(19) United States
(12) Patent Application Publication
(10) Pub. No.: US 2003/0139953 A1
(43) Pub. Date: Jul. 24, 2003

(54) Method and system for role analysis

(76) Inventors: Daniel Guenther, Morrison, CO (US); Janet Anderson, Westminster, CO (US)

Correspondence Address: Finnegan, Henderson, Farabow,, Garrett & Dunner, L.L.P., 1300 I Street, N.W., Washington, DC, 20005-3315, US

(21) Appl. No.: 10/053,623

(22) Filed: Jan. 24, 2002

(51) Int. Cl. G06F 17/60

(52) U.S. Cl. 705/7

(57) ABSTRACT

Methods and systems in accordance with the present invention perform role analysis to assist organizations with the identification of emerging technical roles related to current and future business requirements. In one implementation, methods and systems in accordance with the present invention identify roles of an organization and map the identified roles to appropriate training so that personnel may efficiently develop skills needed to perform the identified roles. Since job roles vary worldwide with respect to responsibilities even within similar job titles, role analysis helps standardize the roles. While within a given job title there may be considerable variance, the various job roles hold in common certain technical “core tasks.” Role analysis methods and systems in accordance with the present invention evaluate and document the common core tasks that are needed to fulfill business requirements for an organization.

### FIELD OF THE INVENTION

The present invention generally relates to role analysis and/or data processing systems for performing role analysis. More particularly, methods and systems consistent with the present invention relate to analysis of roles, such as job requirements, the determination of skill gaps, and training needs of personnel within an organization.

### RELATED ART

Many industries, such as the Information Technology (“IT”) industry, are swiftly evolving fields with rapidly changing needs and demands. In recent times, the booming IT industry has created new business requirements and technical needs for companies and organizations that change very quickly. To run efficiently, a company must employ well-trained IT professionals who are prepared to weather these changes and to handle unexpected events without negatively effecting the company or organization. Examples of such events may be migrating to a new business application, installing new or different hardware, moving from an Internet Service Provider (“ISP”) to an Application Service Provider (“ASP”), etc.

In ensuring that personnel are adequately trained and prepared, IT companies in particular need to determine what needs to be done, identify who is supposed to be doing it, and determine if they are able to do it. They also need to determine what skill gaps there are in their organization and determine what training would fill these gaps. In addition, they need to know what training has been given or, what is already known, to avoid redundant training.

Many IT organizations are growing so fast that roles and functions are both undefined and often unclear. Many employees do not know the specific functions of their jobs and do not know the aspects of their jobs for which they would need training. Businesses also change focus, for example, moving from being an ISP to an ASP. Such a change in focus often involves changes in both processes and functions among personnel making individual roles become even more unclear. Also, many IT managers do not have a sufficient level of experience to understand the difference in technical roles required among such functional areas as fault management, configuration management, security management, etc.

Additionally, traditional job descriptions may not accurately reflect the work that the IT professional is required to perform due to the need for versatility. For example, an organization might deploy a new level of technology, move from an ISP to an ASP, or acquire an enterprise-level server. Several people may then find themselves with new duties due to that technical acquisition or change. The new acquisition of duties results in “ad hoc” work, some of which may be temporary, and some of which may evolve into a permanent part of the person's job description. Small or mid-size organizations often find themselves without the appropriate resources identified to support new technical acquisitions. Accordingly, a need arises for correctly and efficiently analyzing jobs to be performed and their requirements.

A report by the Gartner Group, G. Raphaelian, “Trends in IT Job Definitions,” October 1996, which is incorporated herein by reference, goes further to describe emerging trends in the area of roles for employees in IT organizations. Specifically when traditional job descriptions are too narrow, work roles afford the enterprise greater flexibility in defining responsibilities without casting the employee as one specific type of worker or another. Several other documents also describe concepts related to roles for employees including Cascio, “Applied Psychology in Personnel Management” (Prentice Hall, 1978, Chapters 4 and 10), Nadler et al., “Organization Architecture: Designs for Changing Organizations” (Jossey-Bass, 1992, Chapters 2 and 5), and Robinson & Robinson, “Performance Consulting: Moving Beyond Training” (Berrett-Koehler Publisher, Inc., 1995, Chapter 7), which are incorporated herein by reference.

Additionally, IT employees are constantly acquiring new knowledge on different platforms and tool sets as an organization's technology changes. This high level knowledge of acquisition drives massive change in roles and the tasks performed, and may further impact traditional job descriptions that are not fluid enough to accurately reflect an individual's work. The massive and rapid changes occurring in the IT business create a desire for the analysis of personnel, jobs, requirements, and training.

Job roles vary worldwide with respect to responsibilities, even within similar job titles. This variance is due to a number of factors having to do with levels of technology, available resources, and organizational size. To take one example, a network engineer in a small company may perform a greater variety of tasks and have different responsibilities as compared to a network engineer in a large company. In large companies, for example, network engineers may focus more on specific tasks. In smaller companies, a network engineer may have to be more of a generalist. For example, in a small company, the network engineer may be responsible for tasks ranging from recovery, back-up, incident management, security management, as well as the standard tasks associated with the network engineer job title, such as network implementation, configuring and resolving network equipment, troubleshooting and resolving network problems, managing remote access networking servers, building new routers and switches, auditing and documenting network configuration, remote access implementation and administration, etc. As such, it is desirable to identify standard aspects that the jobs have in common to identify the business requirements. The lack of understanding of consistent job roles makes the development of training solutions increasingly difficult.

Accordingly, a need arises for efficient and effective tools to analyze job requirements with respect to business and technical needs, the determination of organizational skill gaps, and the appropriate training to fulfill the determined needs.

### SUMMARY OF THE INVENTION

In accordance with an implementation consistent with the present invention, a method for role analysis in an organization is provided. The method comprises determining categories of roles of the organization, and reviewing documents related to the roles of the organization. The method further comprises interviewing subject matter experts within the organization to obtain information related to the roles in the organization, and creating one or more role analysis profiles based on the reviewed documents and interview information. The method also comprises validating the created role analysis profiles, and creating final role analysis profiles based on the validation.

In accordance with another implementation consistent with the present invention, a method for role analysis in an IT organization is provided. The method comprises determining core tasks of the IT organization, and determining training needs for the IT organization based on the determined core tasks of the organization.

In accordance with yet another implementation consistent with the present invention, a method for role analysis in an IT organization is provided. The method comprises determining core tasks of the IT organization, and reorganizing one or more members of the IT organization based on the determined core tasks of the organization.

In accordance with still another implementation consistent with the present invention, a method for role analysis in an IT organization is provided. The method comprises receiving information from the organization related to roles and core tasks. The method further comprises creating role analysis profiles based on the received information, and determining training needs for the IT organization based on the created role analysis profiles.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a HENDERSON part of this specification, illustrate an embodiment of the invention and, together with the description, serve to explain the advantages and principles of the invention.

FIG. 1 illustrates an overview of an exemplary role analysis process in accordance with an implementation consistent with the present invention;

FIG. 2 illustrates a block diagram of an exemplary computer system suitable for use in accordance with an implementation consistent with the present invention;

FIG. 3 depicts a job having various roles in accordance with an implementation consistent with the present invention;

FIG. 4 illustrates a role with core tasks, formal training, process knowledge, technical knowledge, and critical event handling in accordance with an implementation consistent with the present invention;

FIG. 5 shows a hierarchy of components associated with personnel in an IT organization in accordance with an implementation consistent with the present invention; and

FIG. 6 depicts the stages for one implementation of performing role analysis in accordance an implementation consistent with the present invention.

### DETAILED DESCRIPTION

Organizations may make determinations of job requirements and desired training through “role analysis.” A role is a discreet job function and may comprise a set of skills. Role analysis is a process used to identify and validate high-level “core tasks” in order to clarify the work roles required by an organization for efficient and reliable operation. The role analysis process determines the extent to which the work performed by the organization's IT professionals is aligned with current or future business and/or technical requirements of the organization.

An organization may benefit from role analysis in a number of ways. For one, the organization is better able to understand the various roles of the organization, and with this understanding, it can create better training and learning-related solutions. Role analysis also permits the segmentation of training offerings more appropriately for a given audience, i.e., workers of the organization. The business-related benefits that arise from role analysis include improving role clarity and the way in which various roles align with business requirements.

Methods and systems in accordance with an implementation of the present invention perform role analysis to assist organizations with the identification of emerging technical roles related to current and future business requirements. In one implementation, methods and systems in accordance with the present invention identify roles of an organization and map the identified roles to appropriate training so that personnel may efficiently develop skills needed to perform the identified roles.

Since job roles vary worldwide with respect to responsibilities even within similar job titles, role analysis helps standardize the roles. Although within a given job title there may be considerable variance, the various job roles have certain common “core tasks.” Methods and systems in accordance with an implementation of the present invention evaluate and document the common core tasks that are needed to fulfill business requirements for an organization.

In one implementation, the methods and systems consistent with the present invention are applied to IT organizations because core tasks that are technical in nature are generally universal in the IT workplace and may be the same from all organizations. Therefore, one can generalize with validity about the performance outcomes of those core tasks as well as the training required to prepare people to perform those core tasks. As well, because role analysis may be linked to IT-related critical events, one can generalize on the training needs and requirements to perform disaster recovery, etc. Other implementations, however, may also be used.

In one implementation, the methods and systems consistent with the present invention may also use role analysis documentation to provide at least four deliverables: (1) a roles and responsibility matrix, (2) team structure design, (3) custom job descriptions, and (4) staffing level recommendations. A roles and responsibility matrix is a summary, i.e., table or matrix, or mapping of commonly used areas of responsibilities to roles. A team structure design is a high-level description of how the team will be organized to perform various technical functions. Custom job descriptions are summaries of a given job's areas of responsibilities and core tasks, customized to meet the organization's unique needs. Finally, staffing level recommendations are projections for staffing roles based upon a determination of needs. Other implementations, however, may also be used.

In one implementation, the methods and systems consistent with the present invention may also provide certain results. For example, the methods and systems may produce a completed role analysis report using a “Role Analysis Survey” format. The methods and systems may also produce a “core task” template (described below) that maps an organization's roles to certification training requirements, such as SunTone™ certification from Sun Microsystems, Inc. These methods and systems may be performed by computers or people or various combinations of both. Other implementations, however, may also be used.

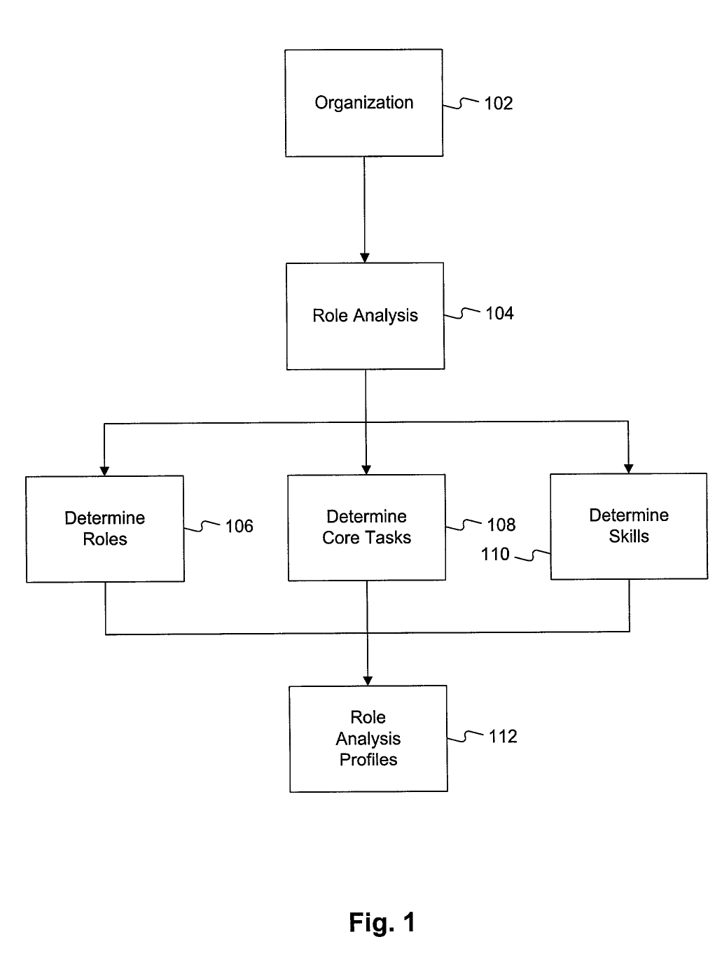

FIG. 1 illustrates a diagram of an overview of a role analysis process in accordance with an implementation consistent with the present invention. An organization (stage 102) decides to have role analysis performed on the organization (stage 104) to evaluate personnel and training needs. To do so, information is gathered and the organization is examined to determine the roles (stage 106), core tasks (stage 108) and skills (stage 110) of personnel of the organization (these terms are described in detail below.) Finally, the roles, core tasks and skills are interpreted and compiled to create role analysis profiles, also described below, which, in one implementation, may be used by an organization to determine training needs, arrange personnel, determine skill gaps, etc.

Computer Architecture

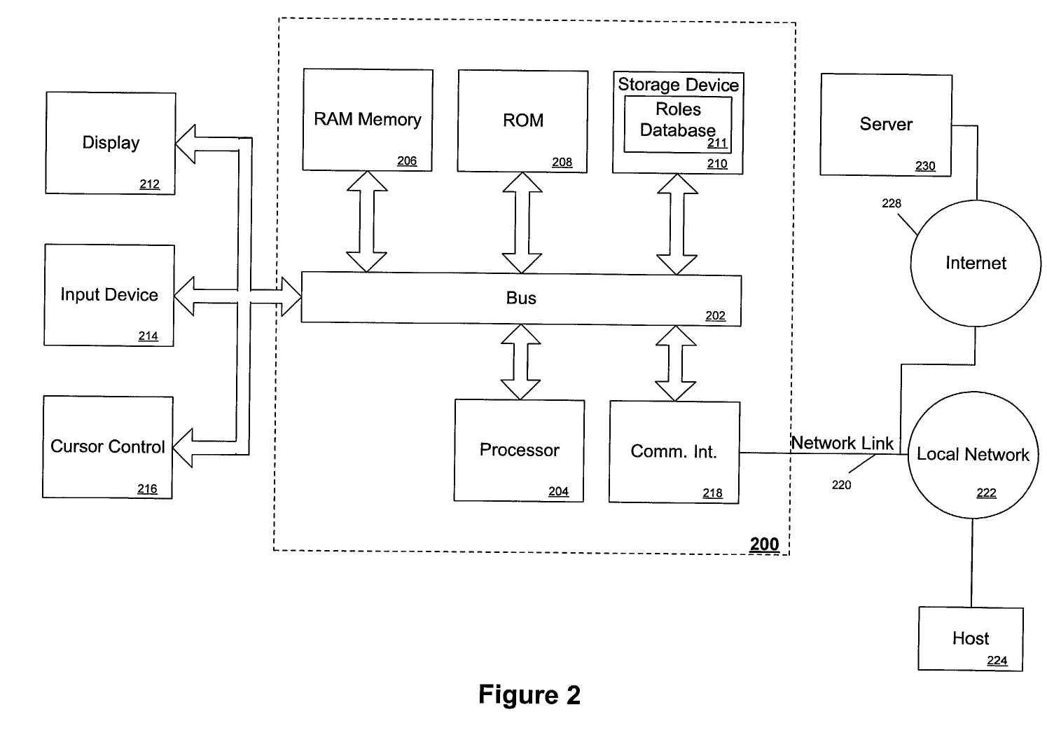

FIG. 2 is a block diagram that illustrates a computer system 200 in which methods and systems consistent with the present invention may be implemented.

Computer system 200 includes a bus 202 or other communication mechanism for communicating information, and a processor 204 coupled with bus 202 for processing information. Computer system 200 also includes a main memory 206, such as a random access memory (“RAM”) or other dynamic storage device, coupled to bus 202 for storing information and instructions to be executed by processor 204. Computer system 200 further includes a read only memory (“ROM”) 208 or other static storage device coupled to bus 202 for storing static information and instructions for processor 204. A storage device 210, such as a magnetic disk or optical disk, is provided and coupled to bus 202 for storing information and instructions. Storage device 210 or memory 206 may contain roles database 211, which may store, among other things, previously created roles and associated core tasks, training requirements, process knowledge and technical knowledge, and critical events.

Computer system 200 may be coupled via bus 202 to a display 212, such as a cathode ray tube (“CRT”), for displaying information to a computer user. An input device 214, such as a keyboard, is coupled to bus 202 for communicating information and commands to processor 204. Another type of user input device uses cursor control 216, such as a mouse, for communicating with processor 204 and for controlling cursor movement on display 212.

Computer system 200 also includes a communication interface 218 coupled to bus 202. Communication interface 218 provides a two-way data communication coupling to a network link 220 that may be connected to local network 222. For example, communication interface 218 may be a modem, for example, to provide a data communication connection. As another example, communication interface 218 may be a local area network (“LAN”) card to provide a data communication connection to a compatible LAN or a wireless network card to provide a connection to a wireless network. Communication interface 218 sends and receives electrical, electromagnetic, or optical signals that carry digital data streams representing various types of information.

Network link 220 typically provides data communication through one or more networks to other data devices. For example, network link 220 may provide a connection through local network 222 to a host computer 224 or to a wide area network (“WAN”), such as the Internet 228. Local network 222 and Internet 228 both use electric, electromagnetic or optical signals that carry digital data streams. The necessary signals through the various networks and the signals on network link 220 and through communication interface 218, which carry the digital data to and from computer system 200, are exemplary forms of carrier waves transporting the information.

Other implementations may also be used for computer system 200 or for the components connected to computer system 200 via bus 202 or communication interface 218.

Method and System Details

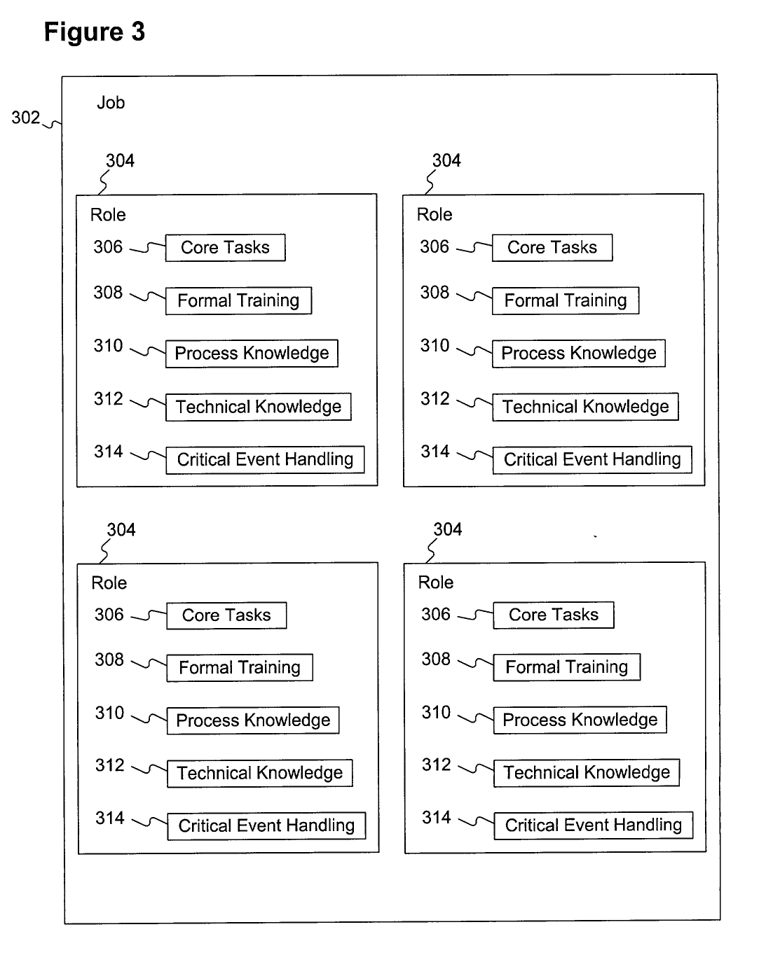

FIG. 3 depicts a job 302 having associated roles 304 with core tasks 306 and skills 308-314 in accordance with an implementation of the present invention. A role 304 is a discreet job function, and in one implementation, a job function becomes a role 304 when at least 20% of the worker's time involves performing that function. Within a given job 302, there may be several roles 304. One criterion of a role 304 is that it requires knowledge and skill in a specific technical area for performance, and an example of a specific role is “Solaris™ System Engineer.” In this implementation, role 304 comprises a set of core tasks 306 and a set of skills including formal training 308, process knowledge 310, technical knowledge 312, and of critical event handling 314. In this implementation, roles 304 are mapped to skill, training, and problem solving areas that have been established over time and are well defined in roles database 211. Other implementations may also be used.

For example, new roles 304 may be defined in terms of new core tasks 306 and set of skills 308-314, e.g., that need to be performed when a new technology, emerges in the market. Thus, as organizations acquire new technology, there are corresponding new roles 304 that arise, and these new roles 304 need to be defined by way of and mapped to core tasks 306. These new roles 304 may be added to the database as they develop.

Roles 304 are mapped to core tasks 306, which are high level performance activities and may be used as defining units of performance for a role. For example, a core task 306 in an IT organization may be “to provide database administration.” Core tasks 306 are units of performance or “performance activities” that are common across IT technologies. Core tasks 306 may also complete a milestone or step in a process, which is the defining sequence of events, steps or phases that need to be performed in order to meet business requirements. In one implementation, one test of a core task 306 is that it can be mapped to a core process and/or to a high-level output needed to meet a business requirement. In one implementation, role 304 may be either a “functional role” 304 and “product specific role” 304, which are both different types of roles 304 and are described below. A “functional role” 304 may be defined by a set of core tasks 306 needed to perform an activity unique to a role. For example, a functional role 304 of a relational database administrator may commonly involve several core tasks 306, such as: 1) providing database administration, 2) planning capacity for databases, 3) performing backup and restoration, 4) performing trouble-shooting, and 5) performing tuning. A functional role 304 may also be defined by researching industry standards and evolving technology. Evaluation of functional roles 204 may lead to solutions such as job descriptions, staffing level estimates, and team structure. A functional role 304 may also be, to some extent, the foundation for product-specific roles.

A “product specific role” 304 may be defined by a set of core tasks 306 required to perform an activity unique to a specific product. A product specific role 304 may be created by taking the core tasks from a functional role and customizing them to a particular product or by utilizing existing product-specific courseware. For example, a product specific role 304 for a relational database administrator may be for example, those roles associated with such database products as Oracle, Sybase, Informix, or DB2. Generally, a product specific role 304 is used to assess an organization's skill level relative to a specific product.

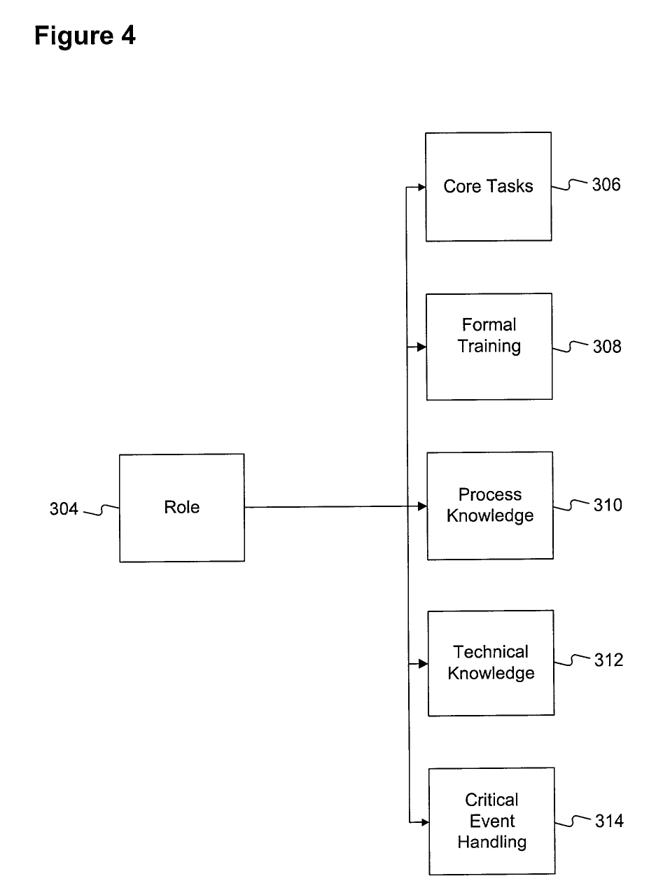

A core task 306 is a performance activity held in common across an area of IT technology. In the IT business, because of the consistency of core tasks 306, roles 304 may be determined in advance. Because core tasks 306 are linked to a technology or skills, they are dimensions of performance that allow for the development of pre-determined roles 304 which define a set of skills needed to perform in a given area of technology and may be stored in the roles database 211. In one implementation in accordance with the present invention, the information gathered during the role analysis process is compared to the core tasks 306 and pre-determined roles 304 contained in the role database 211. Additional components of FIG. 3 are discussed in regard to FIG. 4.

FIG. 4 is a more detailed view of a role with core tasks, formal training, process knowledge, technical knowledge, and critical event handling in accordance with an implementation consistent with the present invention. FIG. 4 shows that, in one implementation, each role 304 has associated (1) core tasks 306, (2) formal training 308, (3) process knowledge 310, (4) technical knowledge 312, and (5) problem solving skills 314 required to handle critical events. Generally, formal training 308 involves the level of formal training required to perform the role. Process knowledge 310 involves work instructions, procedures, etc., and technical knowledge 312 represents knowledge involved in operating and handling various software, hardware, etc. Furthermore, a critical event is an occurrence that shuts down a system or process to the extent that there is a negative business impact in terms of service level agreements and/or other expected business outcomes.

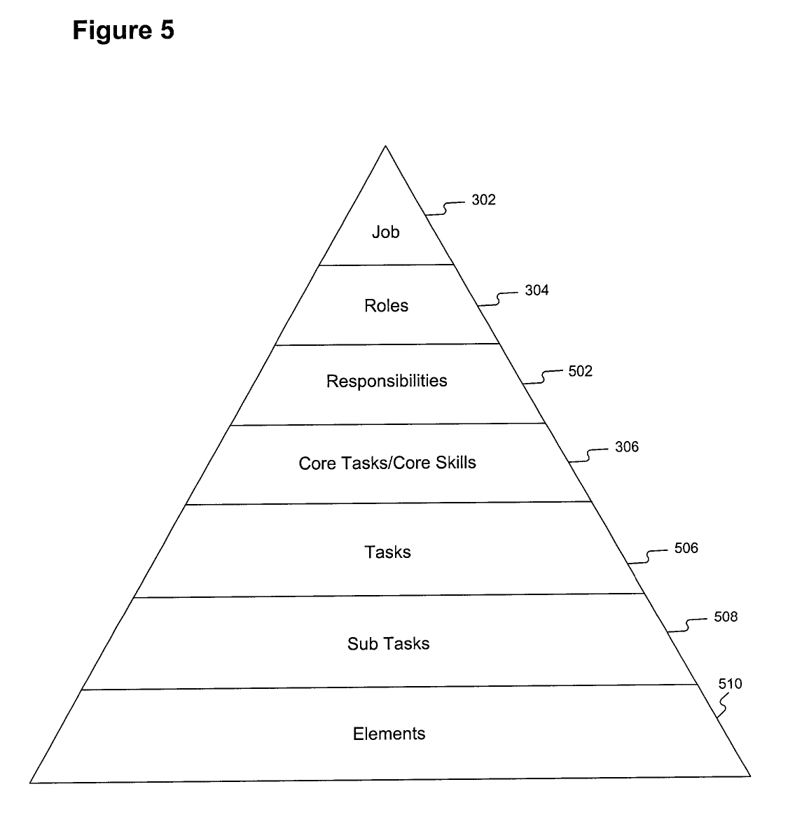

FIG. 5 shows a hierarchy of components associated with a job 302 in an IT organization. In this implementation, a role 304 is a discreet job function related to a technical work requirement. Within a given job 302, there may be a number of functional roles 304.

A “responsibility” 502 is a high-level accountability area or component of a role 304 that maps to both levels of required skills as well as levels of required performance. In one implementation, a criterion test of a responsibility 502 is a goal or series of performance requirements for which the job incumbent is held accountable.

An example of a responsibility 502 is “to design a Sun Ray™ system to ensure availability and reliable performance.” Responsibilities 502 may also be used to write custom job descriptions, discussed below.

As previously mentioned, core tasks 306 are high-level components of role 304. A criterion test of a core task 306 is that it can be mapped to the core business process. A core task 306 may complete a milestone in a core process, and core tasks require specific levels of knowledge and skill to perform in a technical area. An example of a core task 306 is “to specify network infrastructure needed.”

“Tasks” 506 are what must be accomplished on the job or, in other terms, the performance result expected. They are more specific than a core task 306. In one implementation, the criterion test of a task is an output or performance result. The output of a task can be assessed against specific criterion in terms of quality, quantity, timeliness, appropriateness, etc. An example of a task is to “in accordance with guidelines, identify by number specifications for ethernet cable needed.”

In contrast, a skill is a level of proficiency with respect to how the task is performed or how well the task is accomplished. Skills and knowledge, i.e., know-how, are brought to the work by a job incumbent. Knowledge and skills are pervasive throughout the role and task hierarchy. The job incumbent applies skills to produce the output. The criterion test of a skill (or know-how) is that it is a required element in the process to produce the output.

“Sub-tasks” 508 are more detailed components of a task. Knowledge and skills are pervasive throughout the task and sub-task hierarchy. An example of a sub-task is to “verify that switches are daisy-chained in accordance with design.”

“Elements” 510 are more detailed components of a sub-task. Knowledge and skills are pervasive throughout the sub-task and element hierarchy. An example of an element is to “verify by count and documentation process that the number of switches does not exceed specification.”

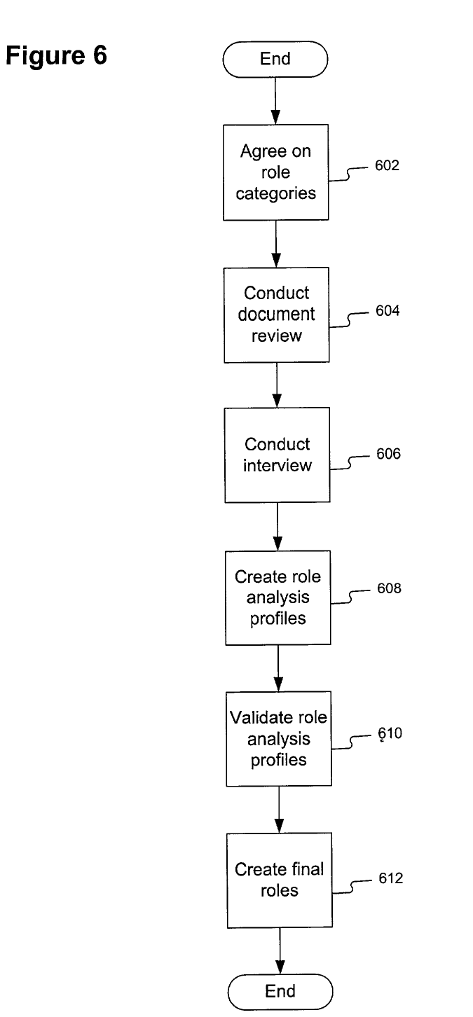

FIG. 6 shows the stages for one implementation of performing role analysis in accordance with the present invention. Many of these steps may be performed by a computer or a person (or persons), or a combination of both. Many of the steps may be performed by a person entering information into a computer that is transmitted over a network to a computer such as computer 100 having a roles database 211. The person or persons performing role analysis steps are referred herein to as “consultants.” Also, the entity, company or group that is being analyzed is referred to as the “organization.”

As shown in FIG. 6, consultants agree on “role categories” with the organization (stage 602). Role categories are high-level technical functional areas such as system administration, network administration, storage administration, security, etc. The determination of role categories assists in the segmentation of the audience (workers of the organization) for further analysis, and the managers of the organization segment the audience for data gathering purposes based on the role categories into audience segments. The consultants determine subject matter experts from each audience segment (i.e., group of workers in a role category) and role category, and in one implementation, acquire management approval for the subject matter experts to participate in the role analysis. The subject matter experts may be people particularly knowledgeable in their field or segment. The consultants also determine applicable documentation to be analyzed in the process. The consultants may meet with managers to review and sign off on the plan and process.

The consultants work with their respective audience segments to conduct document review of the organization's relevant documents and documents provided by the managers (stage 604). These documents may include processes, position descriptions, learning content, and product manuals. In collecting documents, consultants may also receive job descriptions, and product and technology descriptions and analyze what the organization is doing, what job descriptions are lacking, and what the organization has to do. The consultants check the existing roles 304 predefined in the roles database 211 to see if they are consistent with the documents being reviewed. In addition, they prepare “core task templates” to use as interview tools. These core task templates may also be stored in roles database 211. An exemplary core task template is shown in Appendix A. As shown, in one implementation, the core task template includes areas for questioning in five areas which are described below.

The consultants then interview the subject matter experts, appropriate workers, or key contributors in an audience segment about roles 304 and core tasks 306 (stage 606). For each job 302, the consultants ask what must be performed to do the job. The consultants explore these areas and evaluate what roles 304 are needed. The consultants then edit and update the core task templates as a result of each interview, and store them in the database 211.

In one implementation, consultants interview the subject matter experts using a five question format, consistent with the core task template. The five questions are directed to determining core tasks 306, formal training 308, process knowledge 310, technical knowledge 312 and handling of critical events 314 for a given role, as shown in FIG. 4.

The first area of questioning involves the technical core tasks 306 required for the role 304. The consultant asks the subject matter expert what are the core tasks needed for this role 304 to determine the core tasks 306. A second area of questioning is the prerequisites required in terms of training/education 308 and level of experience. A relevant question regarding this area may be “what formal training and/or experience would serve as a prerequisite for this role?”

A third area of questioning regards the process knowledge 310 required which include types of procedures, work instructions, install guides, etc. A consultant may ask the subject matter expert to describe the role 304 in terms of process knowledge, i.e., the “how-to's,” procedures, work instructions, etc. A fourth area of questioning is technical knowledge 312 required for types of hardware, platform, etc. The subject matter expert may be asked to describe the role 304 in terms of technical knowledge needed, i.e., the “what's” in terms of hardware, software, etc.

A fifth area of questioning is the level of technical problem-solving 314 required to solve “critical events.” In this questioning, the subject matter expert may be asked to give an example of a trouble shooting challenge, technical problem, or critical event. The answers to these questions are recorded on the core task templates.

In one implementation, consultants compare the responses to the interview questions with roles 304 in the database 211. They get core task 306, training 308, process knowledge 310, technical knowledge 312, and critical event handling 314 information from the subject matter experts and compare it to the roles 304 in the existing roles database 211. If the appropriate roles 304 are already in the database 211, then the information from each existing role is accessed. For a given role 304, the computer may report what skills set (training 308, process knowledge 310, technical knowledge 312, critical event handling 314) are typically needed for that role using the role that is in the database 211. In another implementation, the consultant may access the database 211 and present, for example, the 25 most used roles 304 from database for comparison and analysis. In one implementation, the role database 211 comprises on the order of 100 or more roles 304.

If the role 304 is missing parts in any portion of the training, process knowledge and technical knowledge, then they may be added. If the role 304 is not in the database 211, a new “emerging” role is created accordingly and that role may be added to the role database 211 if it might be reused, possibly by another organization. The role analysis information is maintained in the role database 211, and the database is updated as new jobs, roles, etc. are created throughout the analysis.

One goal of the interview process is to determine if the right core tasks 306 are being used for a given role 304. Generally, the consultants ask the subject matter experts if the consultants are using the right core tasks 306 for the roles 304 that have been chosen. The consultants may either add, delete, or change a core task 306 for a given role 304 if it is not appropriate for the organization. If there are inconsistencies between the roles 304 in the database 211 and the information received from the organization, the consultants check to see if they are performing different roles 304 or different levels of the same role.

Next, the consultants compile the recorded core task template information and group templates by common tasks or responsibility and compile interview data to create “role analysis profiles” also referred to as “straw man” roles (stage 608). In one implementation, role analysis profiles are completed roles 304 having lists of core tasks 306, training 308, process knowledge 310, technical knowledge 312, and critical event handling 314 for a given role.

Tables 1-5, for example, show a sample role analysis profile for the role 304 of middleware specialist.

TABLE 1
Sample role analysis profile for the role of Middleware specialist
Role: This role supports efforts to transform customers' enterprises
to become Internet based.

1. Are these the core tasks for this role?
Develop middleware architectures for customers.
Integrate new applications with legacy systems.
Design and maintain three-tier architecture for customers' enterprises.
Analyze development specifications for applications.
Maintain documentation for middleware designs.
Evaluate new middleware products.
Assist e-commerce programmer in design and development.
Design and configure monitoring procedures for middleware products.
Analyze new versions of existing middleware products and
recommend upgrades.
Maintain operations support manuals with up-to-date middleware
troubleshooting information.

TABLE 2
Sample role analysis profile: Middleware specialist (continued)

2. What formal training and/or experience would serve as a prerequisites
for this role?
Middleware Specialist
Solaris System Admin I (SA-238)
Solaris System Admin II (SA-288)
Solaris TCP/IP Admin (SA-389)
Intro to Netscape Server Infrastructure for E-Commerce Applications
(ECR-2186)
Developing J2EE Compliant Enterprise Java Applications (FJ-310)
Advanced Development with iPlanet Application Server 6.0 (NAS-4211)

TABLE 3
Sample role analysis profile: Middleware specialist (continued)

3. Describe the role in terms of the process knowledge needed?
(i.e, the “how-to's”, procedures, work instructions, etc.)
Assessment of capacity requirements
Development of application architecture
Evaluation of applications
Integration of new applications
Design and maintenance of three-tier architecture
Analysis of existing products

TABLE 4
Sample role analysis profile: Middleware specialist (continued)

4. Describe the role in terms of the technical knowledge needed?
(i.e. the “what's” in terms of hardware, software, etc.)
Knowledge of major framework components such as MQ series,
ORBs/CORBA, middleware routing engines, DCE across heterogeneous
(UNIX,NT) platforms.
Knowledge of enterprise level middleware architecture
Knowledge of three-tier architecture

TABLE 5
Sample role analysis profile: Middleware specialist (continued)

5. What level of technical problem-solving skills is required?
(Give an example of a trouble-shooting challenge, technical problem, or
critical event)
Solves high integration problems with new applications
Nonroutine enterprise level troubleshooting and diagnosis for
middleware products

Appendix B shows examples of completed role analysis profiles. As shown in Appendix B, the completed role analysis profiles are provided, including the appropriate roles 304 having the determined core tasks 306, formal training 308, process knowledge 310, technical knowledge 312 and critical event handling skills 314 for the role. For example, the first role analysis profile shown in Appendix B illustrates an exemplary role analysis profile for an exemplary network architect in an organization. In this example, the information in role analysis profiles were determined from the information gathering process including documentation review and interviewing.

Next, the consultants review the draft role analysis profiles with the subject matter experts in the respective audiences to validate the role analysis profiles (stage 610). In one implementation, these subject matter experts are different subject matter experts than the ones who were interviewed to create the role analysis profiles. The subject matter experts provide feedback, and the consultants make any additions and/or corrections to the role analysis profiles that are desired for that audience segment. The consultants then finalize the report and deliver it back to the managers of the organization (stage 612).

The managers utilize the role analysis profiles to identify skill/knowledge gaps as well as to coach staff with respect to job requirements. Furthermore, the role analysis and role analysis profiles may be leveraged by managers to other technical areas. Managers are able to save both time and reduce hiring costs through the use of the role analysis to target better hiring, by, for example, combining jobs, targeting better candidates, and eliminating unnecessary core tasks 306.

In one implementation, roles 304 and/or core tasks 306 are mapped to specific training requirements, such as SunTone™ certification, for managers. Because a technology has a defined set of core tasks 306, the core tasks can be associated with training courses, and consultants can determine what training is needed for an audience HENDERSON segment of an organization based on the role analysis profiles. Appendix C shows examples of a mapping of roles 304 and core tasks 306 to associated training. As shown in Appendix C, correlations may be drawn from certain core tasks or groups of core tasks to specific training. By analyzing the roles, core tasks and role analysis profiles of an organization, a specific mapping may be made from the core tasks to training programs. This mapping may be stored, for example, in the roles database 211, and may also be progressively developed over time. Using the finalized role analysis profiles and associated core tasks 306, the computer 200 can output the needed associated training based on the mapping of associated training to core tasks, or categories of core tasks, stored on the computer.

Other embodiments of the invention will be apparent to those skilled in the art from consideration of the specification and practice of the invention disclosed herein. Furthermore embodiments of the present invention may be implemented by computer programs that may be stored on computer-readable media. It is intended that the specification and examples be considered as exemplary, with a true scope and spirit of the invention being indicated by the following claims.

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for role analysis in an organization, comprising:
determining categories of roles of the organization;
reviewing documents related to the roles of the organization;
interviewing subject matter experts of the organization to obtain information related to the roles in the organization;
creating one or more role analysis profiles based on the reviewed documents and interview information;
validating the created role analysis profiles; and
creating final role analysis profiles based on the validation.

2. The method of claim 1, wherein the determining step further comprises:
consulting with one or more managers of the organization to determine categories of roles.

3. The method of claim 1, wherein the determining step further comprises:
determining an audience segment in the organization based on the categories to gather data related to roles of the organization.

4. The method of claim 3, wherein determining an audience segment further comprises:
identifying subject matter experts in the organization based on the audience segment.

5. The method of claim 1, wherein reviewing documents further comprises:
reviewing documents that comprise processes, position descriptions, learning content, or product manuals.

6. The method of claim 1, wherein the interviewing step further comprises:
receiving information on core tasks, formal training, technical knowledge, process knowledge, and problem solving skills.

7. The method of claim 6, wherein the receiving step further comprises:
recording the received information on core task templates.

8. The method of claim 1, wherein creating one or more role analysis profiles further comprises:
determining one or more core tasks of the one or more role analysis profiles.

9. The method of claim 8, wherein determining one or more core tasks further comprises:
compiling interview information from core task templates.

10. The method of claim 9, wherein compiling interview information further includes:
grouping core task templates by common core tasks to create the one or more role analysis profiles.

11. The method of claim 9, wherein compiling interview information further comprises:
grouping core task templates by common audience segment to create the one or more role analysis profiles.

12. The method of claim 1, wherein creating one or more role analysis profiles further comprises:
determining formal training, technical knowledge, process knowledge, or problem solving skills.

13. The method of claim 1, wherein validating the one or more role analysis profiles comprises:
reviewing the one or more created role analysis profiles with subject matter experts other than the interviewed subject matter experts; and
receiving feedback from the reviewing subject matter experts.

14. The method of claim 13, wherein receiving feedback from the reviewing subject matter experts further comprises:
modifying the one or more reviewed role analysis profiles based on the received feedback.

15. The method of claim 14, wherein the validating step further comprises:
reviewing the one or more role analysis profiles with managers of the organization; and receiving feedback from the managers.

16. The method of claim 15, wherein the validating step further comprises:
modifying the one or more role analysis profiles based on the review with the managers.

17. The method of claim 1, further comprising:
determining desired training for one or more members of the organization based on the one or more final role analysis profiles.

18. The method of claim 1, further comprising:
determining skill gaps in the organization based on the one or more final role analysis profiles.

19. A method for role analysis in an Information Technology (IT) organization, comprising:
receiving information from the organization related to roles and core tasks;
creating role analysis profiles based on the received information; and
determining training needs for the IT organization based on the created role analysis profiles.
